(19) United States
(12) Patent Application Publication
(10) Pub. No.: US 2026/0070250 A1
(43) Pub. Date: Mar. 12, 2026

(54) UNTETHERED INTERNAL GROOVING METHOD AND APPARATUS USING MAGNETIC FIELD

(71) Applicants: University of Florida Research Foundation, Inc., Gainesville, FL (US); PROTODROMICS, INC., Melbourne, FL (US)

(72) Inventors: Hitomi Greenslet, Gainesville, FL (US); Hiroyuki Matsumura, Gainesville, FL (US); Adam D. Wexler, Melbourne, FL (US)

(21) Appl. No.: 19/109,723

(22) PCT Filed: Sep. 7, 2023
(86) PCT No.: PCT/US2023/073608

§ 371 Date: Mar. 7, 2025

Related U.S. Application Data
(60) Provisional application No. 63/404,207, filed on Sep. 7, 2022.

(51) Int. Cl. B26D 3/16; B26D 3/06; B26D 5/08

(52) U.S. Cl. CPC B26D 3/163; B26D 3/06; B26D 5/086

(57) ABSTRACT

Various examples are provided related to untethered internal grooving. In one example, a method includes inserting a cutting tool into a tubular workpiece; aligning a driving magnet on an outer surface of the tubular workpiece, the driving magnet including poles aligned with poles of magnets of the cutting tool to position a cutter of the cutting tool against an inner surface of the tubular workpiece; and forming a groove on the inner surface of the tubular workpiece by controlling rotation of the workpiece and linear movement of the cutting tool. The cutting tool can include magnets each including poles on opposite sides and a cutter secured between the magnets.

### CROSS REFERENCE TO RELATED APPLICATIONS

This application claims priority to, and the benefit of, co-pending U.S. provisional application entitled “Untethered Internal Grooving Method and Apparatus Using Magnetic Field” having Ser. No. 63/404,207, filed Sep. 7, 2022, which is hereby incorporated by reference in its entirety.

### BACKGROUND

The demand for products with high-quality surface finishing has surged in the past decade. The finished-product demand has made industries working in surface finishing study and develop machining techniques for the delivery of desired target surface finishes, where conventional machining techniques such as lapping, grinding, honing, polishing, and brushing are not able to cope.

### SUMMARY

Aspects of the present disclosure are related to untethered internal grooving. In one aspect, among others, a method comprises inserting a cutting tool into a tubular workpiece, the cutting tool comprising: first and second magnets each comprising N and S poles on opposite sides; and a cutter secured between the first and second magnets and extending from a surface of the cutting tool, where the N and S poles of the pair of magnets align to secure the cutter therebetween the N pole of the first magnet on a first side of the cutter and the S pole of the second magnet on a second side of the cutter opposite to the N pole of the first magnet. The method further comprises aligning a driving magnet on an outer surface of the tubular workpiece, the driving magnet comprising N and S poles, the N pole of the driving magnet aligned with the S pole of the second magnet and the S pole of the driving magnet aligned with the N pole of the first magnet to position the cutter against an inner surface of the tubular workpiece; and forming a groove on the inner surface of the tubular workpiece by controlling rotation of the workpiece and linear movement of the cutting tool.

In one or more aspects, the first and second magnets can be cylindrical with the N pole on a first side of a longitudinal axis and the S pole on a second side of the longitudinal axis. The cutting tool can comprise a tubular case holding the first and second magnets in alignment with the cutter extending through the tubular case. The tubular case can be stainless steel. The surface of the cutting tool can comprise an antifriction coating. The antifriction coating can be frictionless tape. The surface of the cutting tool can have a radius that less than a radius of the inner surface of the tubular workpiece. In some aspects, the tool tip can comprise a metal or ceramic blade. The metal blade can be a steel blade. The ceramic blade can be a tungsten carbide blade.

In various aspects, the cutting tool can comprise a plurality of cutters and a plurality of magnets, wherein each of the plurality of cutters is secured between two adjacent magnets of the plurality of magnets. The plurality of cutters can be aligned to extend from one side of the cutting tool. The plurality of cutters can include cutters extending from opposite sides of the cutting tool. The groove can be a circular groove extending around the inner surface of the tubular workpiece. The groove can be a spiral groove extending along a length of the tubular workpiece. The groove can be formed with a depth in a range from about 20 μm to about 500 μm. The groove can be formed with a depth in a range from about 20 μm to about 1000 μm. A shape of the formed groove can be a V-shape or a rectangular shape. The tubular workpiece can be formed of a non-magnetic material. The tubular workpiece can be copper. The driving magnet can be supported by a linear axis system configured to control the linear movement of the driving magnet along a length of the tubular workpiece.

In another aspect, a method comprises inserting a cutting tool into a tubular workpiece, the cutting tool comprising: a tubular case comprising an end surface at a distal end; a magnet comprising N and S poles on opposite sides, the magnet extending through the tubular casing toward the distal end; and a cutter secured between the end surface and the magnet with the cutter extending through a radial surface of the tubular case. The method further comprises aligning a driving magnet on an outer surface of the tubular workpiece, the driving magnet comprising N and S poles, the N pole of the driving magnet aligned with the S pole of the magnet or the S pole of the driving magnet aligned with the N pole of the magnet to position the cutter against an inner surface of the tubular workpiece; and forming a groove on the inner surface of the tubular workpiece by controlling rotation of the workpiece and linear movement of the cutting tool.

In one or more aspects, the magnet can be cylindrical with the N pole on a first side of a longitudinal axis and the S pole on a second side of the longitudinal axis. The tubular case can be formed of a non-magnetic material. The tubular case can be stainless steel. The surface of the cutting tool can comprise an antifriction coating. The antifriction coating can be frictionless tape. An outer surface of the cutting tool can have a radius that less than a radius of the inner surface of the tubular workpiece. In some aspects, the tool tip can comprise a metal or ceramic blade. The metal blade can be a steel blade. The ceramic blade can be a tungsten carbide blade. The tubular workpiece can be sectioned from the inner surface of the tubular workpiece by the cutting tool.

In various aspects, the groove can be a circular groove extending around the inner surface of the tubular workpiece. The groove can be a spiral groove extending along a length of the tubular workpiece. The groove can be formed with a depth in a range from about 20 μm to about 500 μm. The groove can be formed with a depth in a range from about 20 μm to about 1000 μm. A shape of the formed groove can be a V-shape or a rectangular shape. The tubular workpiece can be formed of a non-magnetic material. The tubular workpiece can be copper. The driving magnet can be supported by a linear axis system configured to control the linear movement of the driving magnet along a length of the tubular workpiece.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of cutting tool, in accordance with various embodiments of the present disclosure.

FIGS. 2A-2C illustrate examples of magnetic field assisting machining using a cutting tool, in accordance with various embodiments of the present disclosure.

FIGS. 3A and 3B are images illustrating a system utilizing movable cutting tools, in accordance with various embodiments of the present disclosure.

FIGS. 4A-4H illustrate examples of cutting tools, in accordance with various embodiments of the present disclosure.

FIG. 5 includes images illustrating use of the system of FIGS. 3A and 3B with a cutting tool of FIG. 4G, in accordance with various embodiments of the present disclosure.

FIG. 6 is a table illustrating experimental conditions, in accordance with various embodiments of the present disclosure.

FIGS. 7A and 7B include images illustrating parallel groove cutting results using the cutting tool on acrylic tubing, in accordance with various embodiments of the present disclosure.

FIGS. 8A and 8B illustrate examples of test results cutters and groove geometries, in accordance with various embodiments of the present disclosure.

FIG. 9 includes images illustrating spiral groove cutting results using the cutting tool on acrylic tubing, in accordance with various embodiments of the present disclosure

FIG. 10 illustrates examples of test results cutters and groove geometries, in accordance with various embodiments of the present disclosure.

FIGS. 11A and 11B include images illustrating parallel groove cutting results using the cutting tool on copper tubing, in accordance with various embodiments of the present disclosure

FIGS. 12A and 12B illustrates examples of test results cutters and groove geometries, in accordance with various embodiments of the present disclosure.

FIGS. 13A-13C illustrate examples of untethered cutting tools and magnetic field assisting machining, in accordance with various embodiments of the present disclosure.

FIGS. 14A and 14B are images illustrating a system utilizing movable cutting tools, in accordance with various embodiments of the present disclosure.

FIGS. 15A and 15B illustrate an example of a driving magnet arrangement, in accordance with various embodiments of the present disclosure.

FIG. 16 includes images of blades and cutting tools with small and large magnets, in accordance with various embodiments of the present disclosure.

FIGS. 17A-17C illustrate examples of change in magnetic force with clearance, in accordance with various embodiments of the present disclosure.

FIGS. 18A and 18B illustrate examples of changes in large knife-edge cutting tools with time, in accordance with various embodiments of the present disclosure.

FIGS. 19A-19D illustrate examples of groove geometries using small wheel cutting tools, in accordance with various embodiments of the present disclosure.

FIGS. 20A and 20B illustrate examples of grooving characteristics using small cutting tool with wheel blade, in accordance with various embodiments of the present disclosure.

FIG. 21 includes images of a small cutting tool with a thick knife-edge blade, in accordance with various embodiments of the present disclosure.

FIGS. 22A-22C illustrate examples of grooves formed with small and large cutting tools with knife-edge blades, in accordance with various embodiments of the present disclosure.

FIGS. 23A and 23B illustrate examples of acrylic tubes grooved with a small cutting tool with thick knife-edge blade, in accordance with various embodiments of the present disclosure.

FIG. 24 illustrates an example of copper tube grooved with a small cutting tool with thick knife-edge blade, in accordance with various embodiments of the present disclosure.

FIGS. 25A-25C illustrate an example of an acrylic tube grooved with a small cutting tool with a steel blade, in accordance with various embodiments of the present disclosure.

### DETAILED DESCRIPTION

Disclosed herein are various examples related to untethered internal grooving. An innovative methodology is proposed to form microgrooves on an internal tube surface through a machining mechanism based on the principle of magnetic force for a greater flexibility and lower mechanical constraint. A cutting tool was designed, fabricated, and used for this purpose. Reference will now be made in detail to the description of the embodiments as illustrated in the drawings, wherein like reference numbers indicate like parts throughout the several views.

The present discloser presents a magnet-based cutting tool to achieve internal grooving of an inner tube surface. The cutting tool comprises magnets positioned on opposite sides of a cutter to secure it in position. These magnets are arranged with N-S and S-N poles aligned on opposite sides of the cutter to firmly hold it in position. By controlling a driving magnet on the tube's external side, the cutting tool can be moved and simultaneously pulled towards the tube's inner surface to form the microgrooves.

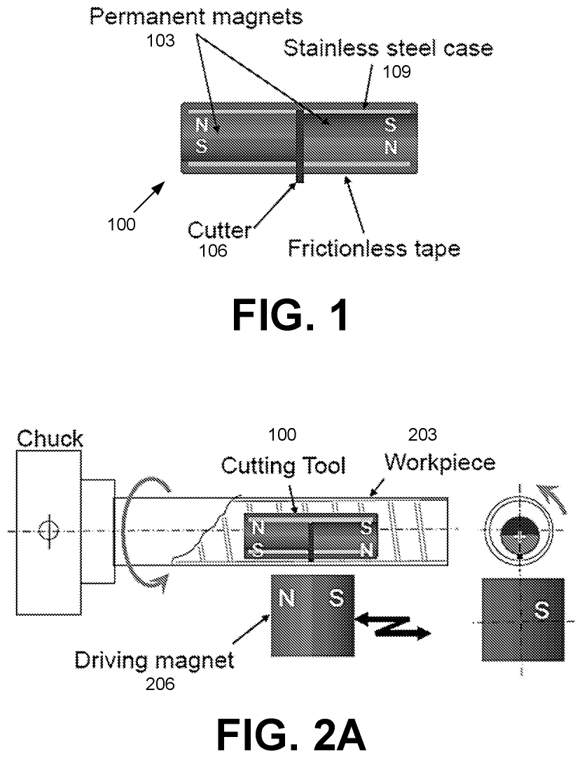

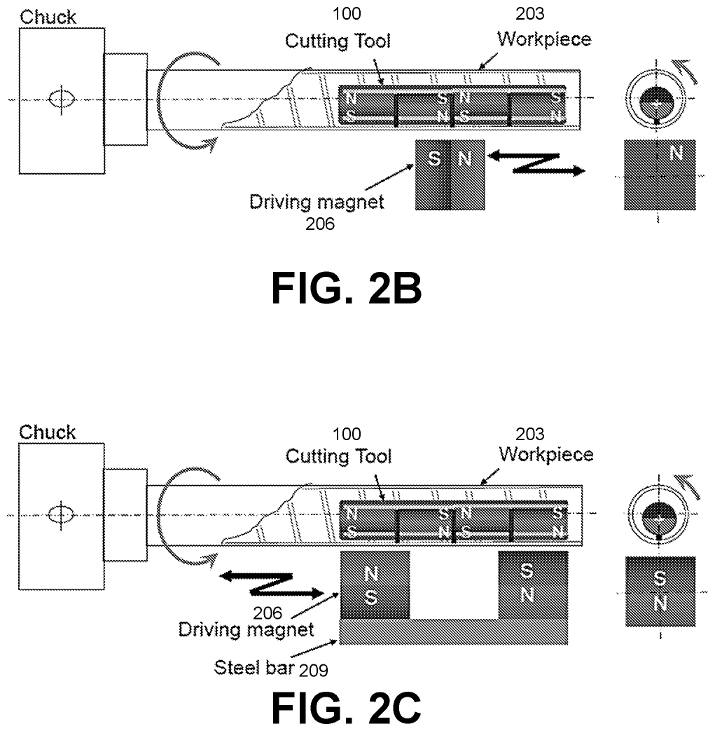

Referring to FIG. 1, shown is an example of a cutting tool 100 for grooving of an inner surface of a tubular workpiece such as, e.g., a copper, aluminum, or polymer tube. As illustrated in FIG. 1, the cutting tool 100 comprises first and second magnets 103 positioned on opposite sides of a cutter 106 (e.g., a metal or ceramic blade). The magnets 103 can be permanent magnets configured with N and S poles on opposites sides of the magnet (e.g., opposite sides of a longitudinal axis of the magnet 103 as illustrated in FIG. 2A). With the N and S poles aligned on opposite sides of the cutter 106, the magnetic field pulls the ends of the magnets 103 together securing the cutter 106 in position. The cutter 106 can be held with the blade edge extending from one side of the cutting tool 100 without extending from the opposite side. The cutting tool 100 can also include a case 109 (e.g., a stainless-steel case) surrounding the magnets 103. The case 109 can include a slot or opening to allow the cutter 106 to extend beyond the outer surface of the case 109. The cutting tool 100 can be assembled by inserting the cutter 106 through the slot or opening in the case 109 and inserting the magnets 103 from opposite ends, securing the cutter 106 in position. In other implements, additional cutter(s) 106 can be added by securing them between adjacent magnets 103. For example, the case 109 can include two slots or openings allowing two cutters to be secured between magnets 103. The openings can be on the same or opposite sides of the case 109.

FIG. 2A illustrate the use of a cutting tool 100 to fabricate groove in an inner surface of a tubular workpiece 203. The workpiece 203 can be placed in a jig or chuck as shown in FIG. 2A to control rotation of the tubing during processing. The cutting tool 100 can be placed inside the workpiece 203 to perform the grooving. As discussed, the cutting tool 100 comprises magnets 103 that secures the cutter 106 in position so that a blade or cutting edge extends beyond an outer surface of the cutting tool 100.

A driving magnet 206 positioned outside the tubular workpiece 203 includes N and S poles that align with the poles of the magnets 103 of the cutting tool 100 as shown in FIG. 2A. The driving magnet 206 provides a magnetic force pressing (or pulling) the cutter toward the inner surface of the tubular workpiece 203. Rotation of the workpiece 203 with the applied force forms a groove in the inner surface. The applied force can be varied by adjusting distance between the driving magnet 206 and the cutting tool 100, varying magnetic strength of the driving magnet 206, etc.

By controlling the orientation of the driving magnet 206 with respect to the cutting tool 100, the cutting tool 100 can be pressed against the inner surface as illustrated in the side view. By reversing the driving magnet orientation, the cutter 106 can be rotated away from the inner surface allowing for movement along the length of the workpiece 203 without producing a groove. In the case where cutters 106 extend from opposite sides of the cutting tool 100, different cutters 106 can be included to produce different groove geometries.

FIG. 2B illustrates an example of a cutting tool 100 comprising a plurality of cutters 106 secured between multiple magnets 103. As can be seen in FIG. 2B, the poles on adjacent magnets 103 alternate to hold the cutters 106 in place. In FIG. 2B, three cutters 106 are shown secured between four magnets 103. While the cutters 106 are uniformly distributed from each other, the distances between cutters 106 can be varied depending on the results. In FIG. 2B, a single driving magnet 206 aligned with the inner magnets 103 of the cutting tool 100 provides the magnetic force to pull the cutters 106 against the inner surface of the workpiece 203. The arrangement can help center the cutting tool 100 about the driving magnet 206. As described, repositioning the driving magnet 206 along the length of the workpiece 203 moves the cutting tool 100 within the workpiece 203. FIG. 2C illustrates a pair of driving magnets 206 magnetically coupled to a ferromagnetic bar (e.g., a steel bar). The driving magnets 206 are positioned to align with the outer magnets 103 of the cutting tool 100 to provide the magnetic force to pull the cutters 106 against the inner surface of the workpiece 203. Other arrangements and combinations are also possible as can be understood. Repositioning the driving magnets 206 along the length of the workpiece 203 moves the cutting tool 100 within the workpiece 203.

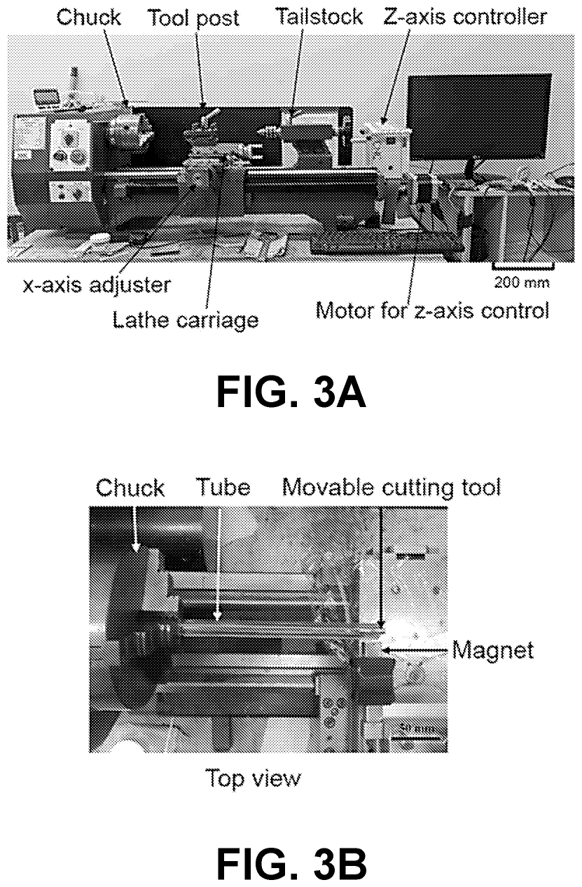

FIGS. 3A and 3B illustrate a setup for testing the cutting tool. FIG. 3A illustrates the components of the overall system and FIG. 3B illustrates the system with a cutting tool in a workpiece for testing.

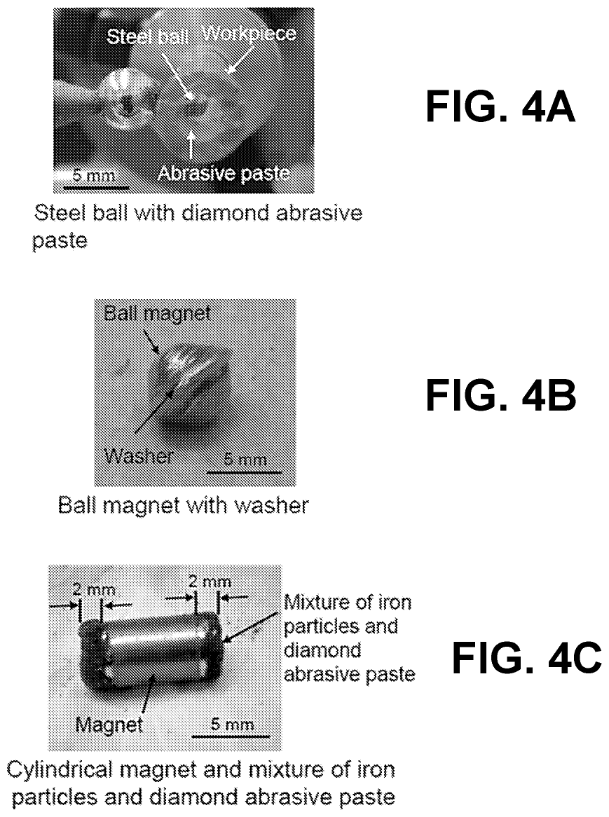

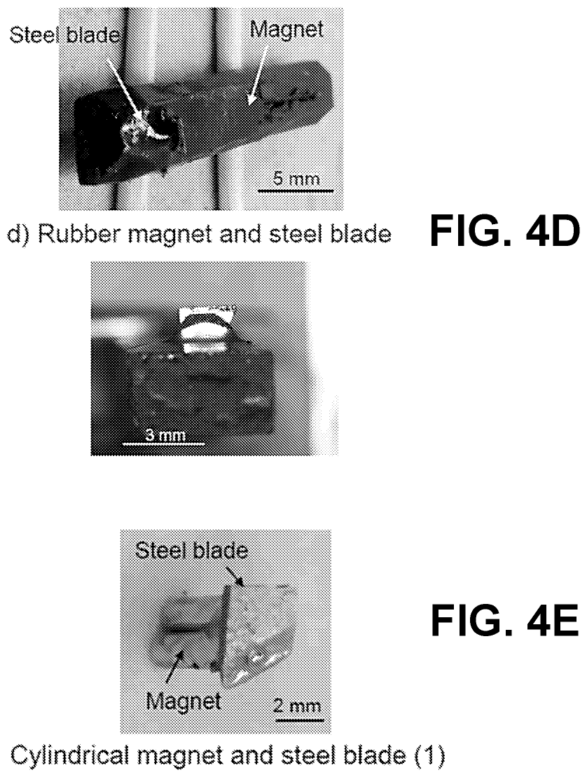

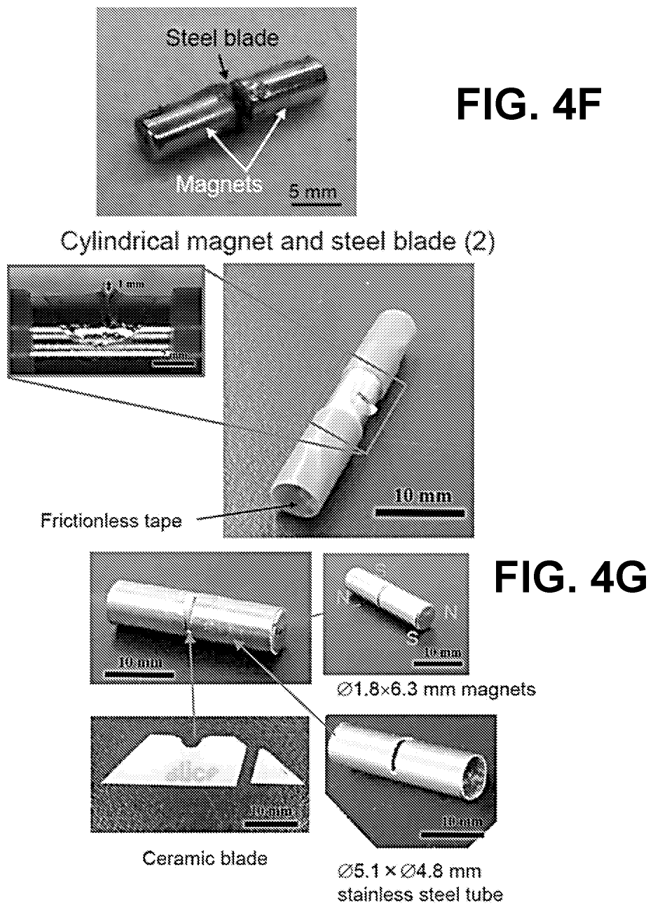

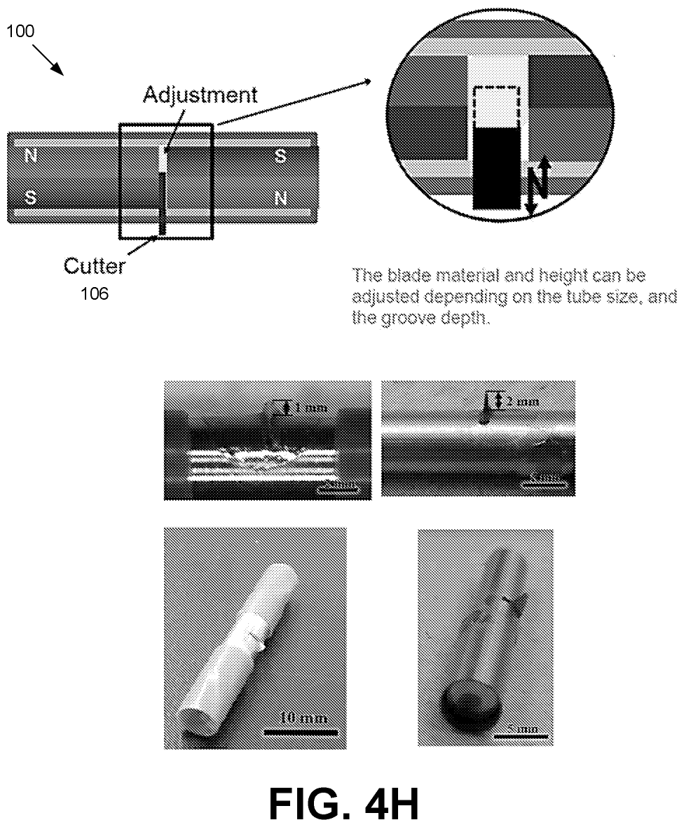

A variety of cutting tools were examined as illustrated in FIGS. 4A-4G. As shown in FIG. 4A, a steel ball with diamond abrasive paste was considered. The steel ball (about 1 mm in diameter) was introduced in a workpiece as shown and attracted to the side of the workpiece by a ball magnet (about 5 mm in diameter). The steel ball presses the diamond abrasive onto the inner surface of the workpiece. The cutting performance can be altered by the size of the diamonds in the abrasive paste. However, the steel ball exhibited vibrations and was difficult to maintain in the desired position. It was also observed that the magnetic force acting on the ball was not strong enough to create deep groove. Next, FIG. 4B shows a ball magnet with a washer for use as a cutting tool. The washer was installed on a ball magnet (about 5 mm in diameter) as the cutter. While this configuration was easy to control tool position, the ball magnet exhibited vibrations so that a stable cutting motion was not obtained.

A cylindrical magnet with a mixture of iron particles and diamond abrasive paste was also examined as illustrated in FIG. 4C. A mixture of iron particles and diamond abrasive was glued on both ends of a cylindrical magnet (about 6.3 mm in diameter and about 12.7 mm in length). This configuration provided easy control of the tool position. It also avoided the vibration of the ball configuration of FIGS. 4A and 4B. However, it was observed that once the cutting operation begins, the mixture was removed from the cylindrical magnet and scattered inside the workpiece. The scattered abrasive mixture can produce random scratches on the inner surface.

FIG. 4D illustrates a cutting tool comprising a rubber magnet with a steel blade. As can be seen in the end view, a piece of a steel blade was placed on one end of the rubber magnet as the cutter. The flexibility and elasticity of the rubber magnet was effective at holding the cutter in position. However, the magnetic force acting on the rubber magnet was too weak to create grooves on the workpiece surface.

A cylindrical magnet with a steel blade was also considered as shown in FIG. 4E. Two cylindrical magnets (about 1.8 mm in diameter and 6.3 mm in length) were connect to each other diametrically, with a piece of a steel blade glued to one end of the magnet as the cutter. This cutting tool was able to generate uniform grooves. The tool position was also easy to control. However, the magnets were attracted to the driving magnet more than the steel blade. This caused either separation of the steel blade from the magnets or breaking of the magnets. Because of this, the tool life was limited.

It was found that the use of a cutter positioned between cylindrical magnets was the most effect for the generation of groove in the inner surface of the workpiece. FIG. 4F shows cylindrical magnets on opposite sides of a steel blade. The two cylindrical magnets (about 4.7 mm in diameter and about 9.5 mm in length) were connected linearly with a piece of steel blade installed between the magnets. The magnets generate strong magnetic force needed for creating the grooves in the workpiece. The cutting tool position was easy to control, and the generated grooves were uniform. It was found that the magnetic force between the magnets was much stronger than the gluing force. The glue was not able to hold the magnets in place, causing unstable tool motion. The effective tool life was short.

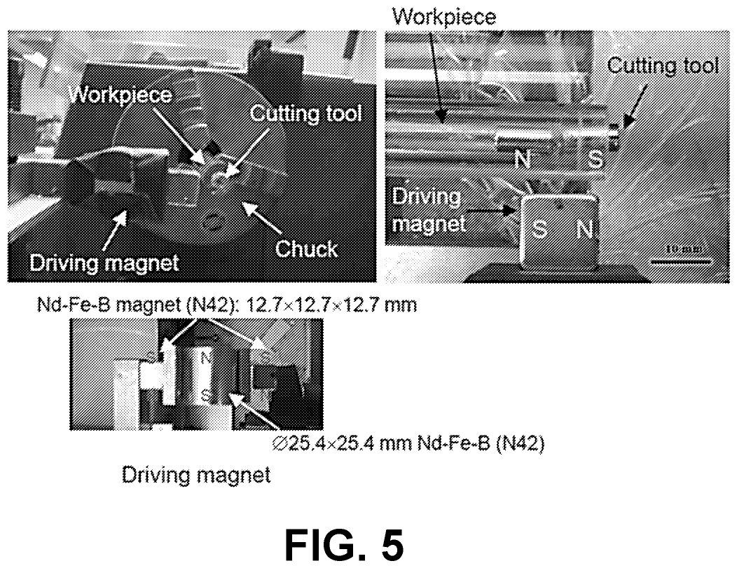

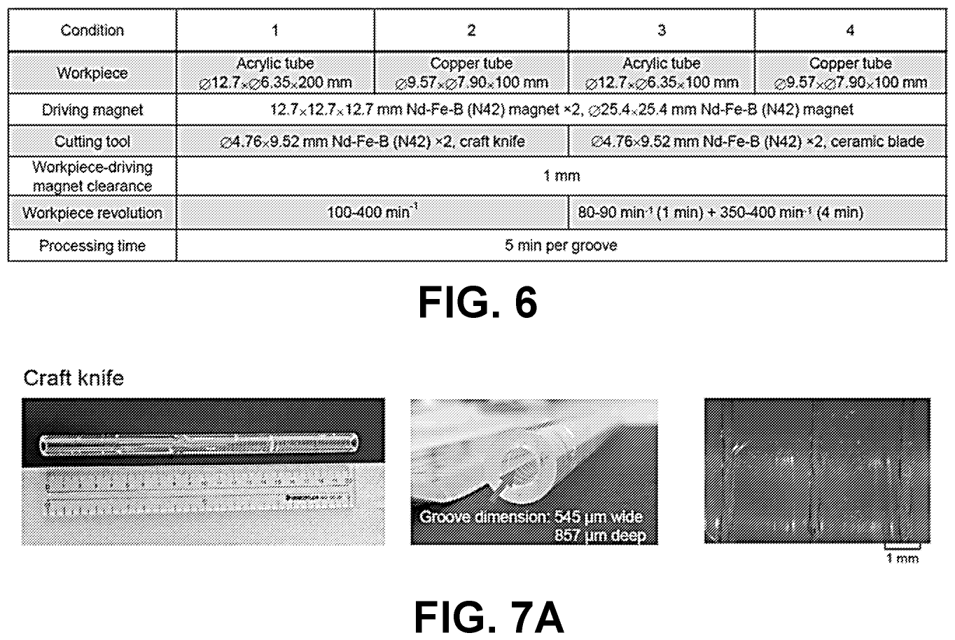

FIG. 4G illustrates an example of the cutting tool 100 of FIG. 1 including a ceramic blade as the cutter 106. As shown, the case 109 included a slot for the cutter 106 to extend through. An antifriction coating such as, e.g., frictionless tape can be applied to the outer surface of the cutting tool 100 to improve operation. The amount the cutter 106 extends outward from the side of the cutting tool 100 can be adjusted as shown in FIG. 4H. For example, a spacer (or adjustment) can be located between the magnets 103 to maintain the height of the exposed blade. The cutter position can vary based upon the side of the spacer, tube size of the case, and/or groove depth. The images in FIG. 4H show cutter heights of 1 mm (on left) and 2 mm (on right). Testing of the cutting tool 100 in FIG. 4G using a craft blade and a ceramic blade was carried out on acrylic and copper tubing. The images of FIG. 5 illustrate the test setup of an acrylic tube with the cutting tool positioned inside opposite the driving magnet. The experimental conditions for various tests are illustrated in FIG. 6.

### Results

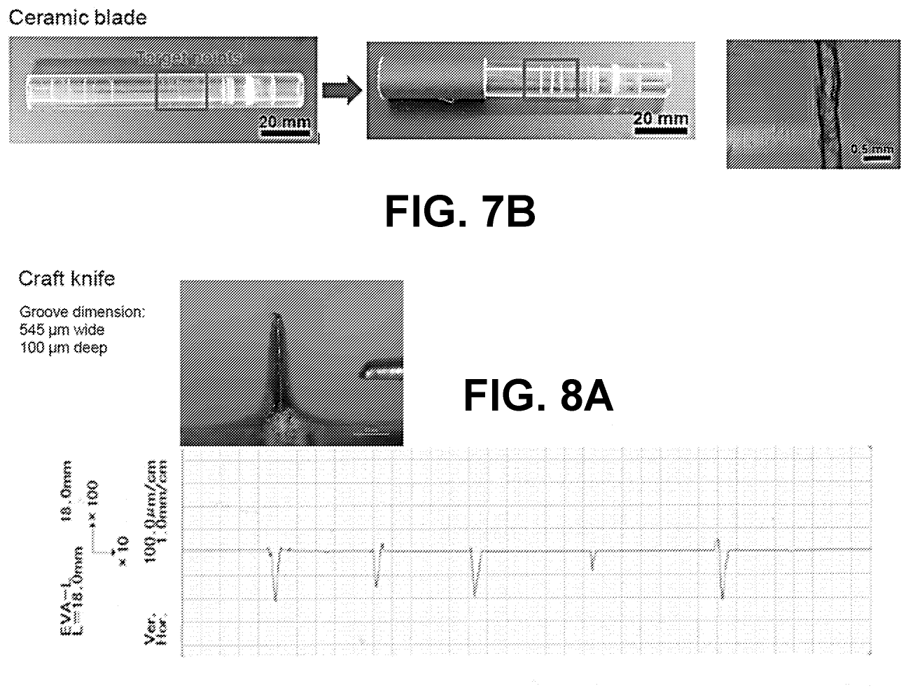

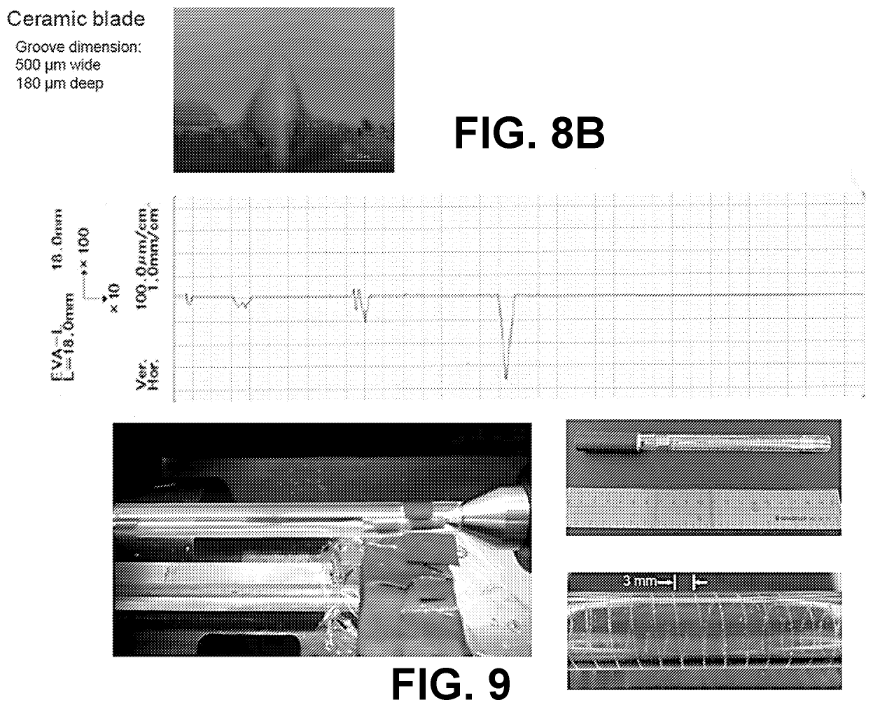

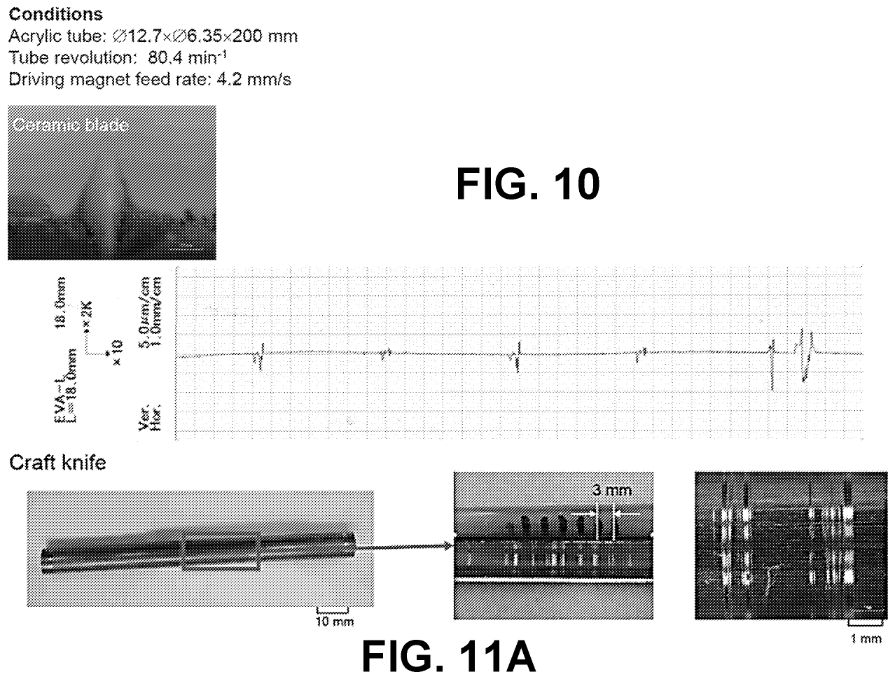

Testing was initially carried out on acrylic tubing. FIGS. 7A and 7B include images of the parallel grooves produced in the acrylic tubes by the craft blade and the ceramic blade, respectively. FIGS. 8A and 8B includes images of each blade and the groove geometries produced in the acrylic tube. FIG. 9 includes images of the spiral groove produced in the acrylic tube and FIG. 10 includes an image of the ceramic blade and the groove geometries produced in the acrylic tube. The configurations of the cutting tool were able to produce 100-500 μm depth grooves.

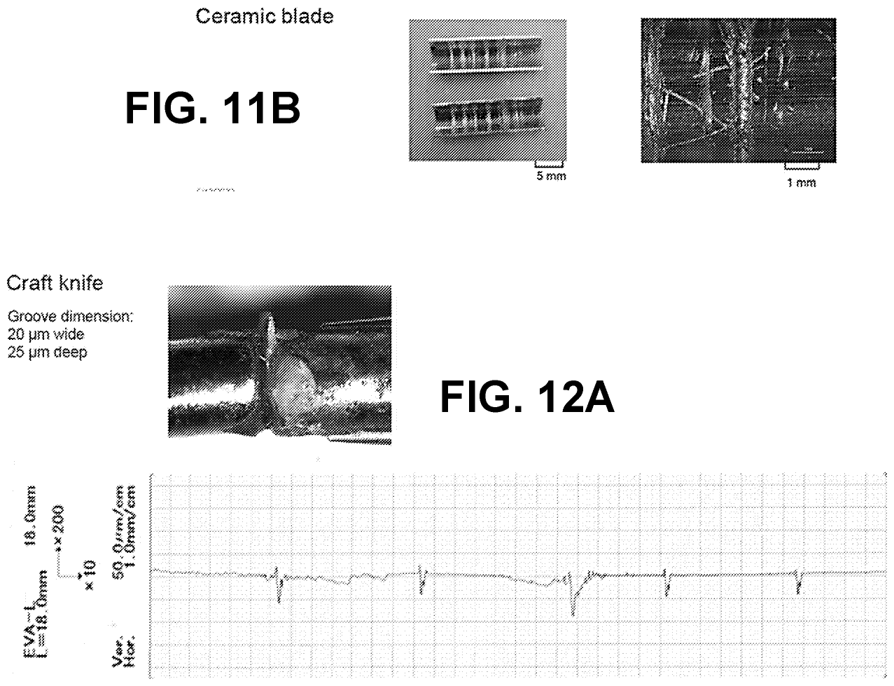

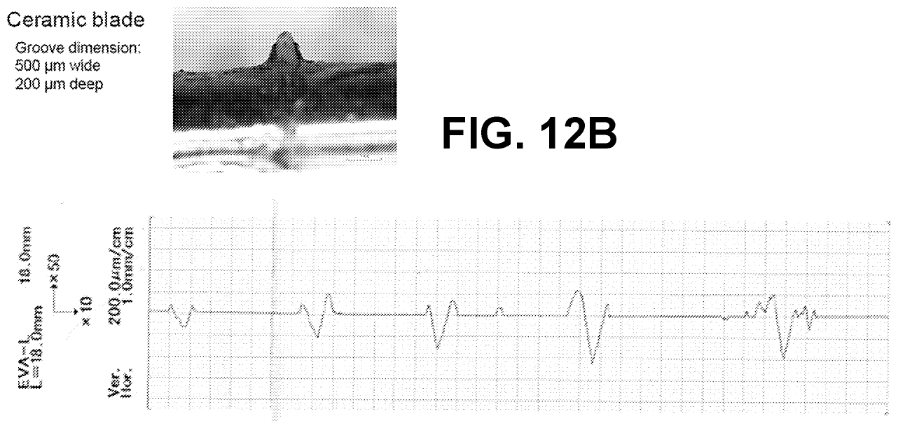

Testing was also carried out on copper tubes. FIGS. 11A and 11B include images of the parallel grooves produced in the copper tubes by the craft blade and the ceramic blade, respectively. FIGS. 12A and 12B includes images of each blade and the groove geometries produced in the acrylic tube. The ceramic cutter was able to produce 100-500 μm deep grooves and the craft blade cutter was able to produce 20-50 μum deep grooves.

A machine with a grooving tool constructed with a closed-magnetic tool was presented that can be controlled in a combined linear and rotational movement, and a fabricated system was successfully used to create an internal groove. Studies have shown that the magnetic grooving tool can produce parallel and spiral V-shape grooves, conforming with its tool tip shape, continuously on an internal surface of acrylic and copper tubes. Translating the cutting tool in the tube axis direction allows the cutting tool to create various geometries other than copying the cutting-tool-tip geometry, including square and rectangular grooves. The depth of the groove could be controlled by adjusting the magnetic field strengths by means of changing the gap distance between the magnets and selection of type and size of the magnets that are used.

Untethered Cutting Tool with Reusable Tool Holder

The development of an untethered cutting tool with a reusable tool holder driven by a magnetic field and the resulting micro-grooving characteristics deep in a tube is described. The cutting tool comprises a blade sandwiched by a pair of permanent magnets (a reusable magnet tool holder), the magnetism direction of which is diametric. The cutting tool enables untethered grooving of a tube interior regardless of the tube length. The feasibility of the developed tool is demonstrated using acrylic and copper tubes by testing the effects of magnetic field and tube rotational speed on the resulting groove geometries and patterns.

Heat-exchanger tubes with enhanced internal surface structures exhibit improved flow-boiling heat transfer and critical heat flux. Manufacturing enhanced surface structures inside a tube (such as features in a grooved wick) is possible using existing manufacturing technologies (e.g., extrusion, cutting, threading, boring, and broaching), and many of these technologies are commercially available. For example, extrusion is applicable for slender tubes, but the groove patterns are limited to the axial direction, and a die or mandrel with a specific groove pattern (e.g., width, depth, clearance between the grooves, and groove angle) needs to be made to create a specific groove pattern and dimensions. Traditional machining processes (e.g., cutting, threading, boring, and grinding) can create groove structures inside a tube as long as the cutting tools or grinding wheels can reach the desired position in the tube. Machining deep in a tube requires a long tool holder and precision control of the cutting tools or grinding wheels, which is challenging for traditional processes.

In internal magnetic abrasive finishing (MAF), a mixture of magnetic tools (e.g., iron particles) and abrasive is suspended by magnetic force in a magnetic field and presses against the internal surface of the tube. As the tube is rotated at high speed, the mixture moves relative to the tube surface and removes material from it. It is possible to influence the motion of the magnetic tool—even if the tool is not in direct contact with a magnet—by controlling the magnetic field. This unique behavior of the magnetic tools enables the application of the finishing operation not only to easily accessible surfaces but also to areas that are hard to reach using conventional mechanical techniques (such as capillary tubes, bent tubes, tapered tubes, and flexible tubes). The magnetic tool is not limited to iron particles; ferrofluids, magnetorheological fluid, cut wires, and permanent magnets can also be used as magnetic tools in internal MAF finishing.

If the mixture is replaced by a cutting blade, the cutting blade can be magnetically pressed against the inner wall surface of a tube and can cut an internal groove deep in the tube. Internal grooving of a copper tube (28.6 mm OD, 0.91 mm thick) was demonstrated using a tungsten-carbide cutting tool mounted in epoxy with a pair of permanent magnets (the assembly is called a magnetic grooving tool). The grooves were made by copying the tool-tip geometry while moving the tool across the tube in one pass, and the grooves were 3-75 μm deep with a width-to-depth ratio of about 10, which cannot be made by abrasive processes. However, since the cutting tool was mounted in epoxy with a pair of magnets, it could only be used once, which is not environmentally friendly. Moreover, the closed magnetic-circuit system, where the magnets were installed behind the cutting tool inside the magnetic grooving tool, limited the application to large-diameter tubes.

Here, an untethered internal micro-grooving technology is presented that uses a cutting tool driven by a magnetic field that results in micro-grooving characteristics deep in a small-diameter tube. The cutting tool comprises a blade sandwiched by a pair of permanent magnets, which works as a reusable tool holder. The principle of the process using an untethered cutting tool will first be presented. The development of the cutting tool and the experimental setup for internal grooving of slender tubes will then be explained. Finally, the feasibility of the developed technology will be demonstrated by testing the effects of magnetic field and tube rotational speed on the groove geometries and patterns in acrylic and copper tubes.

### Processing Principle and Experimental Setup.

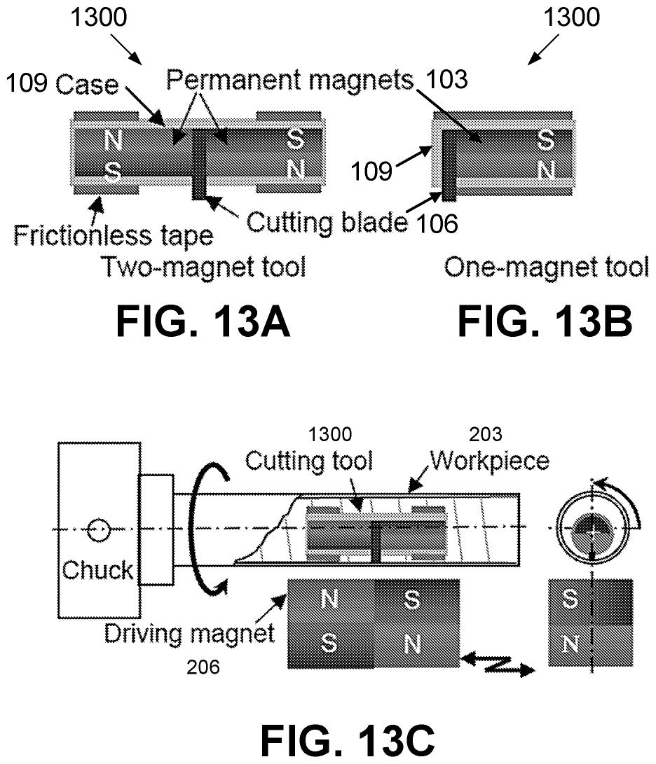

FIGS. 13A and 13B show examples of cutting tools and the processing principle. The magnetically driven cutting tool 1300 can comprise a pair of tool magnets 103 with a cutting blade 106 between them (FIG. 13A). In some embodiments, a cutting blade 106 can be held against the case 109 by one tool magnet (FIG. 13B) to facilitate introduction into and movement in bent or twisted tubes. The magnetism direction of the magnets is diametric. As shown in FIG. 13C, the cutting tool 1300 can be introduced into a workpiece such as, e.g., a nonferromagnetic tube and attracted by a pair of driving magnets 206 placed outside the tube, which drives the cutting tool to a desired location inside the tube. When the tube is rotated, the cutting tool will machine the inner tube surface. The tube rotational speed is equivalent to the cutting speed in this process. The combination of the rotational speed of the tube and the feed rate of the cutting tool creates a variety of micrometer/submillimeter-scale surface structures on the inner tube surface. The total depth of cut is determined by the number of translations of the tool.

As mentioned above, the cutting tool 1300 is suspended in a magnetic field, and the cutting tool 1300 machines the target surface under constant magnetic force acting on the cutting tool 1300. The magnetic force is an independent parameter, and the depth of cut is a dependent parameter; which is opposite to traditional machining mechanisms. In a nonuniform magnetic field, the magnetic force F acts on a magnetic object as described by:

$$F = V χ H \cdot ∇ H \qquad ( 1 )$$

where V is the volume of the magnetic object, χ is the susceptibility, and H and ∇H are the intensity and gradient of the magnetic field, respectively.

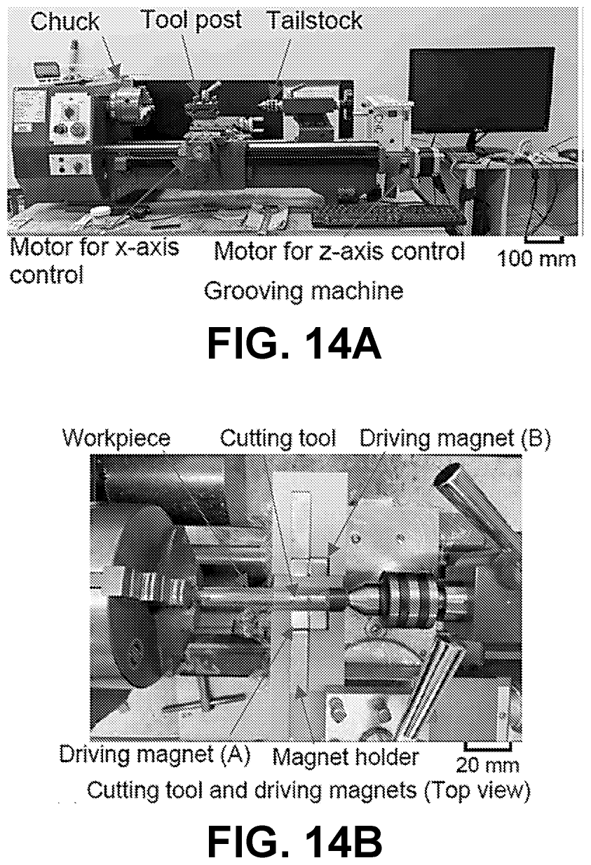

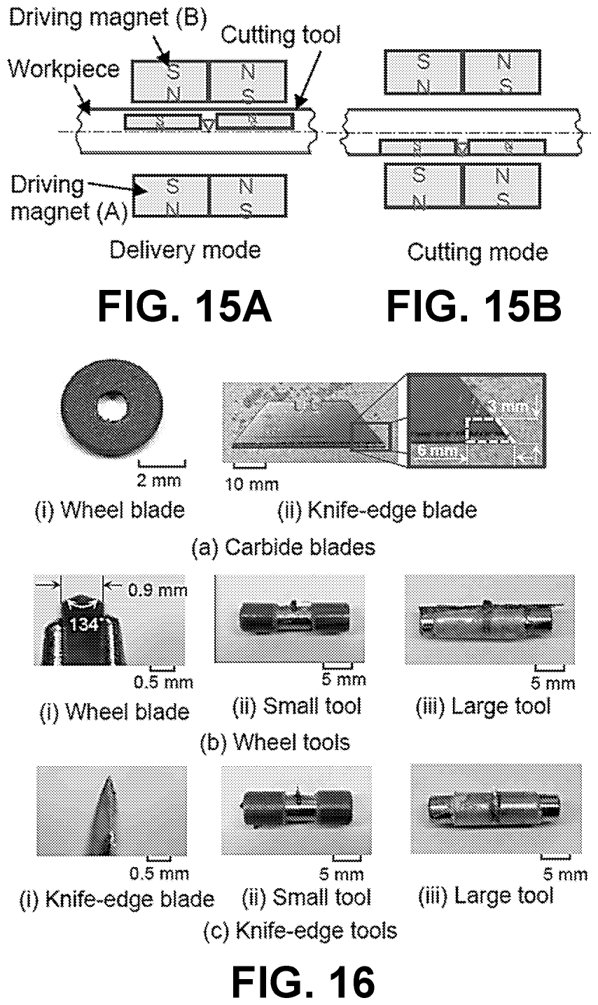

FIGS. 14A and 14B are images showing an experimental setup designed to realize the processing principle. As shown in FIG. 14A, the setup was made by refining a lathe. The spindle speed (i.e., the tube rotational speed) ranges between 30 min−1 to 3000 min⁻¹. The driving-magnet unit is mounted on the lathe carriage and comprises a pair of Nd—Fe—B permanent magnets on each side of the tube (see FIG. 14B). While the driving magnets (B) are meant to attract the cutting tool and drive it to the desired position (FIG. 15A), the driving magnets (A) attract the blade side of cutting tool needed for grooving (FIG. 15B).

### Development of Cutting Tools.

Transparent acrylic tubes (12.7 mm OD, 9.5 mm ID, 150 mm long) and copper tubes (12.7 mm OD, 11 mm ID, 150 mm long) tubes were selected for workpieces. Therefore, cutting tools were developed with small and large Nd—Fe—B cylindrical magnets (Ø4.76×9.53 mm and Ø6.35×12.7 mm, respectively) that can be inserted into those tubes. As the first step, two types of off-the-shelf carbide blades were used as cutting blades: a 0.9 mm thick wheel blade and a 0.6 mm thick knife-edge blade. FIG. 16 shows photographs of the cutting blades 106 and representative cutting-tool assemblies 1300 in which a blade 106 was placed between a pair of magnets 103 before the assembly was inserted in a nonmagnetic case 109 (e.g., a stainless steel tube). The blade 106 protruded through a slot made in the case. To avoid direct contact between the case and workpiece, which causes scratches on the tube, both ends of the case 109 were wrapped with frictionless tape.

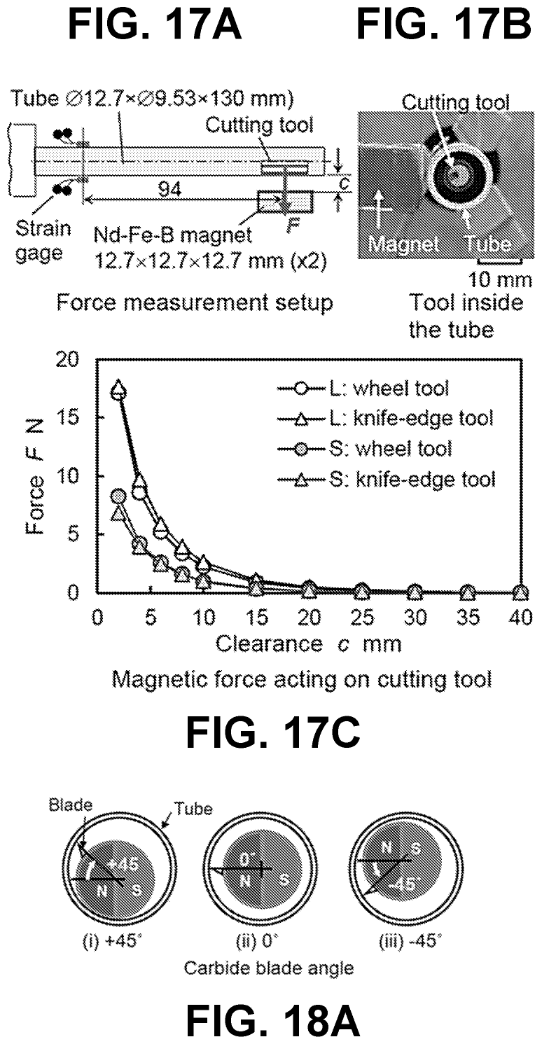

As mentioned above, the magnetic force determines the cutting force; the driving magnets 206 attract the cutting tool 1300, which follows the lines of magnetic force. The magnetic force (independent variable) controls the depth of cut of the blade 106 (dependent variable). In the study, the magnetic force acting on the cutting tools 1300 was measured using strain gauges. FIGS. 17A and 17B show the experimental and measurement configurations, and the measured forces are shown in FIG. 17C. The characters L and S indicate the size of magnets installed in the cutting tools 1300. For example, L: wheel tool denotes a large cutting tool with a wheel blade. The larger cutting tools exhibited greater magnetic force than the smaller cutting tools because the larger tools have larger magnets. For example, at a clearance of 2 mm, the magnetic forces acting on the large tools were about twice as the force acting on the small tools. The volumetric ratio between the large and small magnets was 2.3. According to Eq. (1), the magnetic force is proportional to the magnet volume. Changes in the magnet geometry influences the magnetic field between the cutting tool and the driving magnet. As a result, the force acting on the large tool was nearly double the force generated by the small tool.

The orientation of the blade 106 in the cutting tool 1300 determines the cutting tool contact against the inner surface of the rotating tube (i.e., the rake angle of the cutting tool), especially for the knife-edge tools. This influences both the depth of cut and the tool wear/breakage. For the knife-edge tools, cutting-tool assemblies were made with three blade-orientation angles: +45°, 0°, and −45°, and the effect of the blade orientation angle on the tool behavior was investigated under the conditions shown in Table 1. To observe the tool motion inside the tube, a transparent acrylic tube was used as a workpiece. The clearance between the tube and driving magnets was set at 2 mm. The tube rotational speed was gradually increased to 1000 min⁻¹ at 100 min⁻¹ increments of 10 s each.

TABLE 1
Experimental Conditions

| | |
|---|---|
| Workpiece | Acrylic tube |
| | Ø12.7 × Ø 9.53 × 150 mm |
| Workpiece rotational speed | 0-1000 min⁻¹ |
| | (100 min⁻¹ increment) |
| Cutting tool | See FIG. 16 |
| Driving magnet | Nd—Fe—B magnet (N42) |
| | 12.7 × 12.7 × 12.7 mm (Qty: 2) |
| Workpiece-driving magnet clearance | 2 mm |
| Lubricant | WD-40 |
| Cutting time | 10 s each increment |

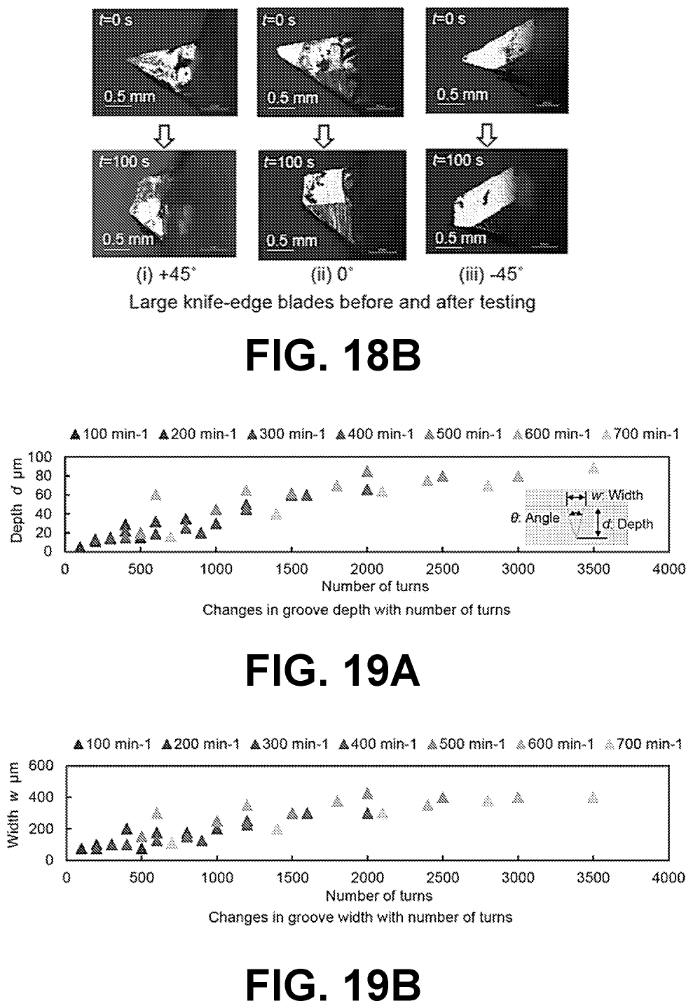

FIG. 18A shows the cutting-tool location inside the tube for each orientation and FIG. 18B shows representative knife-edge blades (in the case of large cutting tools) before and after testing. The tool breakage was the greatest at a blade-orientation angle of +45°. A positive blade-orientation angle facilitated premature chipping and breakage, which decreased with decreasing blade-orientation angle. Accordingly, the cutting tools with the knife-edge blades were insufficient for the conditions listed in Table 1 regardless of the blade orientation angle. In contrast, both the small and large wheel-blade tools demonstrated stable relative motion against the rotating tube under all conditions, and the wheel blades remained unchanged.

In addition to the magnetic force acting on the cutting tool, the tube rotational speed can be an effective parameter influencing the grooving performance. Based on these findings, the fundamental grooving characteristics, effects of tube rotational speed and magnetic force acting on the cutting tool on material removal, were examined using wheel tools.

Grooving Characteristics of Cutting Tools with Wheel Blades.

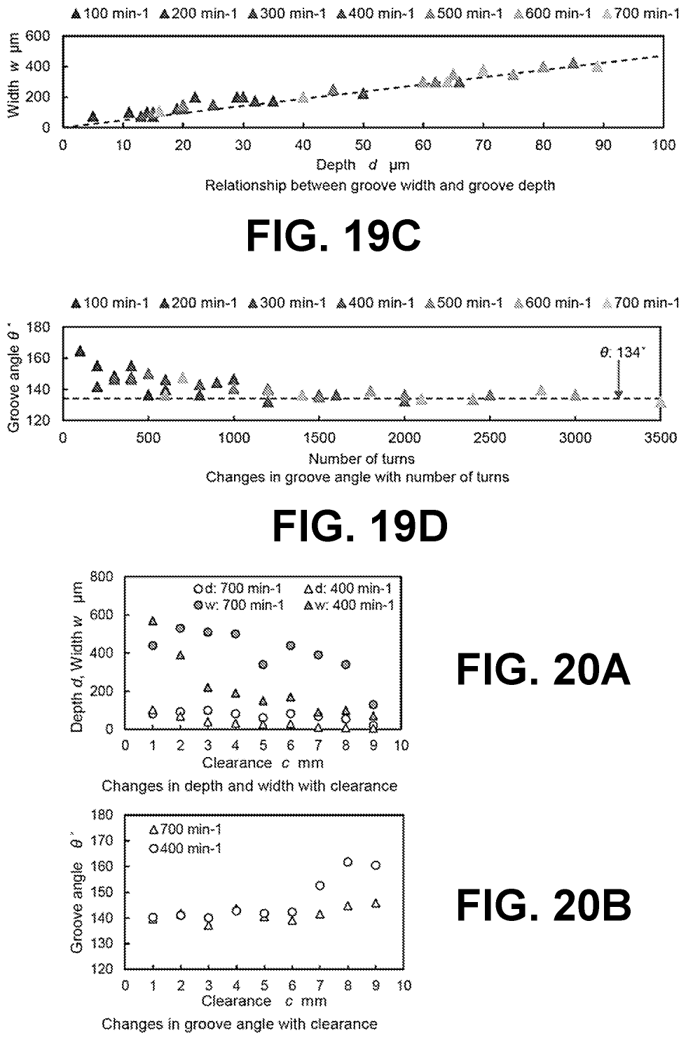

Effect of tube rotational speed on material removal. Table 2 shows the experimental conditions. The tube rotational speed is equivalent to the cutting speed, and the tube rotational speed was varied from 100 min⁻¹ to 700 min⁻¹. The clearance between the tube and driving tool was set at 2 mm. Grooves were made using the wheel-blade tool under various tube rotational speeds, and to clarify the grooving characteristics, the groove width and depth were measured using surface profiles obtained using a diamond stylus roughness tester. All experiments were repeated at least three times to confirm their repeatability, and representative results are shown in FIGS. 19A-19D.

TABLE 2
Experimental Conditions

| | |
|---|---|
| Workpiece | Acrylic tube |
| | Ø12.7 × Ø 9.53 × 150 mm |
| Workpiece rotational speed | 0-700 min⁻¹ |
| Cutting tool | See FIG. 16(b) |
| Driving magnet | Nd—Fe—B magnet (N42) |
| | 12.7 × 12.7 × 12.7 mm (Qty: 2) |
| Workpiece-driving magnet clearance | 2 mm |
| Lubricant | WD-40 |
| Cutting time | 5 min |

FIGS. 19A and 19B show the changes in groove depth and width with the number of tube rotations under various tube rotational speeds (100-700 min⁻¹). The higher the tube rotational speed, the longer the contact length of the wheel blade over the tube surface and the greater the material removal. In addition, all conditions resulted in increased groove depth with increased number of tube rotations. The groove width also increased with increased number of tube rotations. FIG. 19C shows the relationships between the groove width and depth. As shown in the wheel blade image (b-i) of FIG. 16, the measured wheel-blade angle θ of the small cutting tools was 134°, and the dashed line in FIG. 19C is the groove dimension estimated based on the wheel-blade geometry. FIG. 19D shows the changes in groove angle, calculated based on the measured depth and width of the grooves shown in FIGS. 19A and 19B, with the number of tube rotations. The dashed line in FIG. 19D shows the wheel-blade angles.

In the developed process, the cutting tool 1300 was suspended by a magnetic field and untethered. As mentioned previously, the magnetic force is an independent variable, and the depth of cut is a dependent variable; the target surface is machined by the wheel blade under a constant force. As a result, the groove depth and width per tube rotation were nearly constant in the experiments.

At the start of machining, the groove angles were large since the wheel blade did not fully engage with the target surface. In addition, the cutting tool might have tilted to one side, especially at low tube rotational speeds. As grooving progressed, the groove geometries became closer to the wheel-blade geometries, and the groove depth and width both increased.

### Effect of Magnetic Force on Material Removal.

The magnetic force can be adjusted by altering the distance between the magnets 103 in the cutting tool 1300 and the driving magnet 206; in the experiments, this distance can be adjusted by altering the clearance (c) between the tube and driving magnets 206 (see FIGS. 17A-17C). FIGS. 20A and 20B show representative results when using the small cutting tool to cut the tube surface under the various clearances between 1 and 9 mm at a tube rotational speed between 400 min⁻¹ and 700 min⁻¹. The magnetic force decreases with increasing clearance between the tube and driving magnets. Therefore, the groove depth and width both also decreased with increased clearance.

The groove angles calculated using the measured depths and widths are shown in FIG. 20B. The groove angles were about 140° at 700 min⁻¹ and gradually increased with increasing clearance. In the case at 400 min⁻¹, the groove angles were about 140°, and the trend was similar to the case at 700 min⁻¹ up to a clearance of 6 mm. Beyond 6 mm, the groove angle drastically increased as the clearance was increased. As shown in FIG. 19D, a certain number of tube rotations (proportional to the contact length of the cutting tool over the tube surface) is needed to translate the cutting blade geometry across the tube surface. Moreover, the wheel tool needs a certain magnetic force to fully engage the target tube surface. Under the conditions of the tube rotational speed at 400 min⁻¹ with smaller magnetic force, the machining time to achieve the contact length of the cutting tool over the tube must increase. Therefore, the smaller the clearance, the closer the groove angle to the blade angle. The effects are more pronounced at lower tube rotational speed (400 min⁻¹) than at 700 min⁻¹.

Grooving Characteristics of Cutting Tools with Knife-Edge Blades.

It is beneficial to have a sharp cutting edge to create sharp grooves and fine groove patterns on a target surface. However, as mentioned above, the knife-edge blade image (a-ii) shown in FIG. 16 was insufficient to do so in the experiments. To strengthen the knife-edge blade, use of a thick section of original blade (hereafter called thick knife-edge blade) was proposed, and small and large cutting tools with three blade-orientation angles were made.

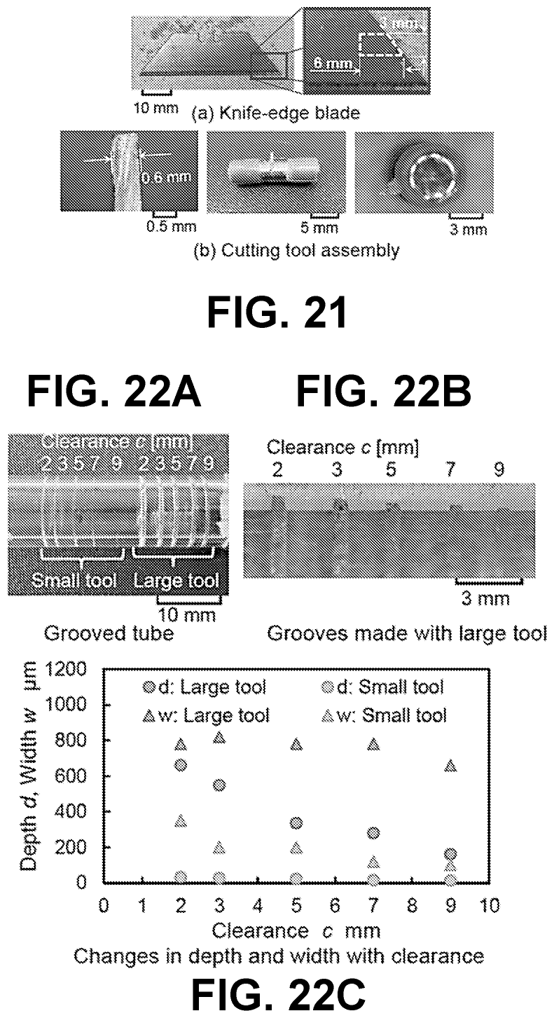

FIG. 21 shows a cutting tool with small magnets installed and the thick knife-edge blade at a blade orientation angle of −45°. The blade-tip thickness was 600 μm. Although the measured force is not shown here, the magnetic force acting on the thick knife-edge tool was the same as the force on the knife-edge tool.

Unlike the knife-edge blades shown in FIG. 18B, the thick knife-edge blades were not chipped during the tool-motion tests conducted under the conditions in Table 1. Instead, the thick knife-edge tool immediately started cutting once the tube rotated. For example, the large thick-knife-edge tool with the thick knife-edge blade at −45° sectioned the acrylic tube from inside after 1 min at 400 min⁻¹. Using the thick knife-edge tool at a blade-orientation angle of −45°, the grooving characteristics were tested under various clearances (2-9 mm) at a tube rotational speed of 100 min⁻¹.

FIG. 22A shows the grooves made using the small and large cutting tools with the thick knife-edge blade. The large cutting tool generated much greater magnetic force than the small cutting tool (see FIG. 17C). The smaller the clearance, the greater the magnetic force acting on the cutting tools. As a result, the grooves made with the large cutting tool are clearer than those made with the small cutting tool through the acrylic tube. The smaller the clearance, the more visible and deeper the grooves. This trend is confirmed in FIG. 22B, which shows the sectional view of the tube wall surface grooved with the large cutting tool.

FIG. 22C shows quantitative analyses of the changes in the groove width and depth with clearance. In the cases with the large cutting tool suspended by a greater force, the cutting tool fully engaged the target surface. As shown in FIG. 21, the thick knife-edge blade here was not perfectly mounted perpendicular to the magnet tool holder, and the cutting tool might have tilted to one side during machining. As a result, the groove widths were greater than the blade width (600 μm) in all cases. In contrast, the groove widths are smaller than the blade width in the cases with the small cutting tool because of the smaller magnetic force. The thick knife-edge blade partially engaged the target surface and grooved the surface. These results demonstrate the feasibility of grooving the inner tube surfaces using the thick knife-edge tools. Using the thick knife-edge tool, the feasibility of producing various groove patterns in acrylic and copper tubes was tested. Since the small cutting tool can more easily move than the large cutting tool, the small cutting tool was used in the following experiments.

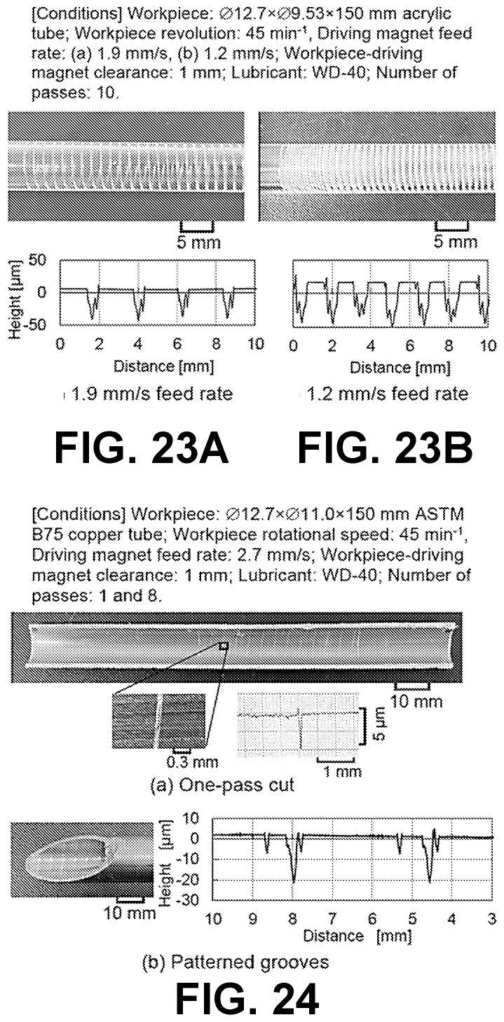

FIGS. 23A and 23B show the cases of spiral grooving of the acrylic tube interior with a small thick knife-edge blade tool at different feed rates. The grooves in FIG. 23A and FIG. 23B were made at 45 min⁻¹ of tube rotational speed with 1.9 mm/s and 1.2 mm/s of the driving magnet feed rate, respectively. The number of passes was 10 at both feed rates, and the groove width and depth were 700-800 μm and 45-60 μm, respectively. The thick knife-edge blade thickness was 600 μm. Note that the groove depth can be increased by increasing the number of passes.

FIG. 24 shows the cases of a single pass and spiral grooving of copper tube interiors with the small thick knife-edge-blade tool. Three groove geometries were made using a constant magnetic force and varying the number of cutting-tool passes. While the shallow spiral groove (about 100 μm wide and 5 μm deep) was made in one pass, and the deep groove was made in eight passes (about 300 μm wide and 23 μm deep).

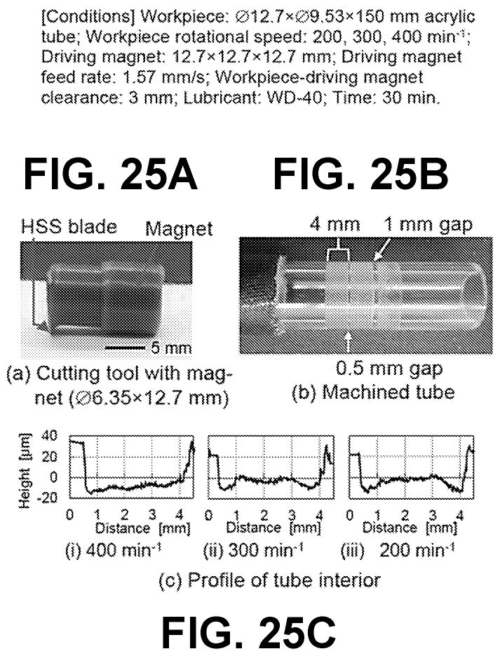

In addition to grooving, boring can be achieved with an appropriate combination of increased tube rotational speed and decreased feed rate of the driving magnet. FIGS. 25A-25C shows an example of boring of an acrylic tube with a cutting tool made from a 0.6 mm thick high-speed steel blade held by a single large magnet. In this single-tool-magnet case, the driving magnet was switched to a 12.7 mm Nd—Fe—B cube magnet to match the cutting-tool-magnet size. The cutting tool was fed back and forth across three 4 mm sections for 30 min each at 1.57 mm/s; the sections were separated by 0.5 mm and 1 mm gaps. The tube rotational speed was at 400 min⁻¹, 300 min⁻¹, and 200 min⁻¹ from left to right in FIGS. 25B and 25C, and the resultant machined depth at the center of each section was about 30 μm, 10 μm, and 10 μm, respectively. The cutting tool dwelled while changing direction at the groove ends while the tube continued rotating (and the machining therefore continued). As a result, deep ends were observed at both ends of the grooves. Although some irregularities were observed, this trial demonstrated the feasibility of using the developed cutting tool for tube boring.

In this disclosure, an untethered internal micro-grooving technology using a cutting tool with a reusable magnet tool holder driven by a magnetic field was developed. The magnetic force acting on the cutting tool acts as the cutting force, and it is an independent variable. The depth of cut is a dependent variable. The target surface was machined by the cutting tool under a constant force. Increasing the depth of cut by increasing the magnetic force and the number of cutting passes leads to increased total groove depth. The orientation of the knife-edge blade influences the rake angle of the cutting tool. The developed process enables creation of various micrometer-scale groove geometries and patterns deep inside acrylic and copper tubes by altering the magnetic force, tube rotational speed, driving magnet feed rate, and number of passes. The parameters can also be adjusted to achieve boring. The developed cutting tool also enables tube sectioning from inside the tube.

These results show that the untethered cutting-tool can enable machining deep inside acrylic and copper tubes using a magnetic force-based actuator. The magnetic force acting on the cutting tool is the major variable influencing the depth of cut. Reducing the size of the cutting tool (i.e., the magnetic blade holder) to introduce the tool into a small-diameter tube inevitably reduces the magnetic force. Slender tubes exhibit vibration at higher tube rotational speeds, which leads to unstable contact between the cutting tool and target surface, altering the depth of cut. Work-hardening of the target surfaces can occur during machining and may influence the depth of cut as the machining progresses.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word “substantially,” even if the term is not explicitly modified by the word “substantially.”

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method, comprising:
inserting a cutting tool into a tubular workpiece, the cutting tool comprising:
first and second magnets each comprising N and S poles on opposite sides; and
a cutter secured between the first and second magnets and extending from a surface of the cutting tool, where the N and S poles of the pair of magnets align to secure the cutter therebetween the N pole of the first magnet on a first side of the cutter and the S pole of the second magnet on a second side of the cutter opposite to the N pole of the first magnet;
aligning a driving magnet on an outer surface of the tubular workpiece, the driving magnet comprising N and S poles, the N pole of the driving magnet aligned with the S pole of the second magnet and the S pole of the driving magnet aligned with the N pole of the first magnet to position the cutter against an inner surface of the tubular workpiece; and
forming a groove on the inner surface of the tubular workpiece by controlling rotation of the workpiece and linear movement of the cutting tool.

2. The method of claim 1, wherein the first and second magnets are cylindrical with the N pole on a first side of a longitudinal axis and the S pole on a second side of the longitudinal axis.

3. The method of claim 1, wherein the cutting tool comprises a tubular case holding the first and second magnets in alignment with the cutter extending through the tubular case.

4. The method of claim 3, wherein the tubular case is stainless steel.

5. The method of claim 1, wherein the surface of the cutting tool comprises an antifriction coating.

6. The method of claim 5, wherein the antifriction coating is frictionless tape.

7. (canceled)

8. The method of claim 1, wherein the tool tip comprises a metal or ceramic blade.

9. (canceled)

10. The method of claim 8, wherein the ceramic blade is a tungsten carbide blade.

11. The method of claim 1, wherein the cutting tool comprises a plurality of cutters and a plurality of magnets, wherein each of the plurality of cutters is secured between two adjacent magnets of the plurality of magnets.

12. The method of claim 11, wherein the plurality of cutters are aligned to extend from one side of the cutting tool.

13. The method of claim 11, wherein the plurality of cutters includes cutters extending from opposite sides of the cutting tool.

14. The method of claim 1, wherein the groove is a circular groove extending around the inner surface of the tubular workpiece.

15. The method of claim 1, wherein the groove is a spiral groove extending along a length of the tubular workpiece.

16. (canceled)

17. The method of claim 1, wherein the groove is formed with a depth in a range from about 20 μm to about 1000 μm.

18. The method of claim 1, wherein a shape of the formed groove is a V-shape or a rectangular shape.

19. (canceled)

20. The method of claim 1, wherein the tubular workpiece is formed of a non-magnetic material.

21. The method of claim 20, wherein the tubular workpiece is copper.

22. The method of claim 1, wherein the driving magnet is supported by a linear axis system configured to control the linear movement of the driving magnet along a length of the tubular workpiece.

23. The method of claim 1, wherein the tubular workpiece is sectioned from the inner surface of the tubular workpiece by the cutting tool.

24. A method, comprising:
inserting a cutting tool into a tubular workpiece, the cutting tool comprising:
a tubular case comprising an end surface at a distal end;
a magnet comprising N and S poles on opposite sides, the magnet extending through the tubular casing toward the distal end; and
a cutter secured between the end surface and the magnet with the cutter extending through a radial surface of the tubular case;
aligning a driving magnet on an outer surface of the tubular workpiece, the driving magnet comprising N and S poles, the N pole of the driving magnet aligned with the S pole of the magnet or the S pole of the driving magnet aligned with the N pole of the magnet to position the cutter against an inner surface of the tubular workpiece; and
forming a groove on the inner surface of the tubular workpiece by controlling rotation of the workpiece and linear movement of the cutting tool.
